(19) United States
(12) Patent Application Publication
(10) Pub. No.: US 2019/0285234 A1
(43) Pub. Date: Sep. 19, 2019

(54) DOWNLIGHT APPARATUS

(71) Applicant: XIAMEN ECO LIGHTING CO. LTD., Xiamen (CN)

(72) Inventors: Zhenyu Tang, Xiamen (CN); Huitang Zhang, Xiamen (CN); Xiaojuan Huang, Xiamen (CN)

(21) Appl. No.: 15/921,635

(22) Filed: Mar. 14, 2018

(51) Int. Cl. F21S 8/02; F21V 17/12; F21V 15/01; F21V 9/08; F21V 5/04; F21V 29/70

(52) U.S. Cl. CPC F21S 8/026; F21V 17/12; F21V 29/70; F21V 9/08; F21V 5/04; F21V 15/01

(57) ABSTRACT

A downlight apparatus has a surface ring, a main cup and an optical component. The optical component is an extended component that may be attached or detached from the downlight apparatus. The surface ring defines a first opening and a containing space. The main cup is connected to the surface ring. The main cup is used for holding a light source. The main cup has a second opening. The light source emits light to the second opening. The optical component is attached to an external connector in the containing space. The optical component is detachable from the external connector by rotation.

### FIELD OF INVENTION

The present invention is related to a downlight apparatus and more particularly related to a downlight apparatus having an external component.

### BACKGROUND

Downlight apparatuses are widely used in our daily life. Downlight apparatuses are usually installed in a cavity in a ceiling for emitting light downwardly. In some countries, there is a standard connection box pre-installed in the ceiling so that users may install their downlight apparatuses into the connection box. In some other countries, downlight apparatuses are installed in a cavity of a ceiling.

There are various issues to be considered when designing a downlight product. For example, heat dissipation, luminance efficacy and cost are some of the major design issues. Along with advancement of technology, LED and various new features are gradually introduced in market products, and also increase human expectation of next generation of downlight products.

In such crowded field, it is very beneficial to find out innovative design that may satisfy human needs more perfectly.

### SUMMARY OF INVENTION

According to an embodiment of the present invention, a downlight apparatus has a surface ring, a main cup and an optical component. The optical component is an extended component that may be attached or detached from the downlight apparatus.

The surface ring defines a first opening and a containing space. The main cup is connected to the surface ring. The main cup is used for holding a light source. For example, the light source is a LED plate or a LED right with an associated light guide. Additional components like one or more heat sink structures, a driver circuit, connecting wires, reflector structures, lens or other components may be provided and disposed in the main cup. A housing made of metal covered with plastic material, pure metal or pure plastic material may be used for meeting different design needs.

The main cup has a second opening. The light source emits light to the second opening. The optical component is attached to an external connector in the containing space, which means the optical component may be partly or completely located in the containing space defined by the surface ring. For example, the surface right may has an external cup structure that defines a containing space in the internal side of the external cup. The optical component also has a cup shape but is located completely within the containing space of the internal side of the external cup of the surface ring.

For common downlight apparatuses, there is a circular ring with one side facing downwardly to users and with the other side facing to a ceiling. There is a hole, i.e. the first opening mentioned above, for letting light of the main cup to emit therefrom.

The external connector is located outside the fixed module. In other words, the surface ring and the main cup form an independent module. Even there is no optical component being attached to the fixed module, the fixed module may still work normally and prevents users directly contact with internal components of the fixed module according to various safety standards.

The optical component is detachable from the external connector by rotation. Magnetic components and other structures may be used for enhancing operation experience or used as an alternative option. The surface ring and the main cup forms a fixed module for fixing in a cavity of a ceiling.

In some embodiments, the optical component is an anti-glare cup. For example, a light emitted from a downlight may cause glare effect, making user eyes uncomfortable. A cup with a wider bottom opening with some surface material may help decrease glare effect of the downlight apparatus.

In some embodiments, the first opening is larger than the second opening. The optical component has a first side and a second side opposite to each other. The first side of the optical component of the optical component is attached to the external connector. The second side of the optical component has a peripheral part to be held by a user to rotate for bringing the first side of the optical component rotated with respect to the external connector to leave connection with the external connector.

In such case, there may be certain space remaining between the surface ring and the optical component so that users may extend part of their fingers in the space to hold the external side of the optical component to rotate the optical component. In one rotation direction, e.g. counter-clockwise, the optical component is fixed to the external connector. In the other direction, e.g. clockwise, the optical component is detached from the external connector.

In some embodiments, since the optical component is exposed outside, compared with components of the main cup, the optical component may stick with dust for a period of time. As mentioned above, the optical component is easily to be detached from the downlight apparatus. Thus, users may detach the optical component to clean and attach the optical component back to the downlight apparatus after cleaning.

In some embodiments, there is another optical component to be rotated to attach to the external connector to replace the optical component when the optical component is detached from the external connector. This means manufacturers may provide multiple optical components with the same types or different types. For example, manufacturers may prepare a kit containing multiple types of optical component to be sold together with the downlight apparatus. Users may replace an original optical component with another optical component to change color, set desired light effect or replacing broken ones.

For example, some optical component may have a reception structure for holding a transparent film slide printed with image pattern of Christmas or birthday marks. When Christmas is coming, users may attach such optical component to the corresponding downlight to create Christmas feeling. After Christmas, users may replace the optical component with a normal optical component.

Therefore, persons of ordinary in the art should know that there are various applications for such designs. Modifications based on such disclosure are supposed to be regarded falling in the invention scope.

In some embodiments, there is a lock component at rotation end of the external connector to lock the optical component. For example, a hook structure using flexible and elastic characteristic of plastic material may be used as the lock for holding the optical component. Unless a larger force is applied, the optical component may robustly stay in its original position defined by the lock component, which prevents the optical component gets loosen during time and falls accidently.

In addition, the lock component may refer to a protective groove, hook or similar structure to prevent the optical component directly falling down. For example, a groove with a curved end may ensure the optical component kept a certain connection with the external connector even the optical component is loosen from the external connector. Users may move in a specific direction to completely detach the optical component from the external connector.

In some embodiments, the first side of the optical component has a smaller perimeter than the second side of the optical component. This design may maximize light output, preventing unnecessary light lost during light transmission path.

In some other embodiments, the first side of the optical component has a larger perimeter than the second side of the optical component. This design may help focus light, cutting unwanted light direction, meeting certain needs.

The first side and the second side of the optical component may even be the same. For example, the optical component may be a lens for changing light beam angle, e.g. the half intensity angle of the downlight apparatus.

In some embodiments, the external connector is located at a bottom of the main cup. In addition, the external connector may have two or more tracks for guiding the optical component when the optical component is rotated with respect to the external connector. Each track may be made of a groove, a convex structure, a concave structure or any other structure that creates a sliding path for attaching the optical component.

Alternatively, the tracks may be disposed on the optical component and the external connector is a convex block, stick or other corresponding structures to slide along the tracks.

In some embodiments, two ends of each convex track has different height. For example, the track may has a lower beginning end and taller ending end.

In some embodiments, the main cup has a cover located at a bottom of the main cup for sealing the main cup, preventing dust entering the second opening of the main cup, and the external connector is located on the cover. The cover may be a diffusion device for passing light and soften light passing through. The cover may be a lens with one convex or concave optical structure, or multiple micro-optical structures for meeting certain optical requirements.

The external connector may be disposed at a bottom end of the main cup where the bottom end surrounds the cover. In other words, the external connector is placed on the cover.

In addition to the external connector, there may be another connector located in the surface ring to further attach to the optical component to form an even more robust fixing connection of the optical component.

Alternatively, the external connector may be located at the surface ring. In other words, the major connection is between the surface ring and the optical component. Please be noted that the surface ring and the main cup may be two separate units but may also be made of a one piece unit, e.g. made with the same molding process.

In some embodiments, the optical component is made of heat dissipation material for helping dissipate heat of the downlight apparatus. The external connector may bring heat of the main cup to be dissipated by the optical component. In other words, in addition to perform as an optical component to adjust light effect of the downlight apparatus, the optical component is also used for enhancing heat dissipation.

Fins, convex structures, metal material or other related features may be further provided in the optical component for even improving heat dissipation.

In some other embodiments, the main cup may have audio components to generate sounds like music received from a mobile phone via wireless connection. The optical component may have a shape for enhancing sound effect of the sound generated from the audio component in the main cup. Such audio component may include wireless circuits, decoders for rendering sound information, driver circuits to drive speakers to generate sound wave, and other necessary components. It is important to adjust sound path to get desired sound effect. An optical component that may be replaced with other structures may be very convenient to change audio effect, by simply replacing the detachable optical component with another optical component of different audio effect.

In some embodiments, the optical component may include a lens for changing a light beam angle of the main cup. For example, the original light may be a diffusion soft light. A focus lens of an optical component may focus the light to form a focused light beam output.

In some embodiments, the optical component may have a color filter for changing color of output light of the downlight apparatus. For example, a red film may bring a red light when the red film is installed on the optical component.

In some embodiments, the optical component may have a spiral convex structure in an internal side of the optical component. Such design may strength structure and may provide better appearance.

### BRIEF DESCRIPTION OF DRAWINGS

FIG. 1 illustrates a cross-sectional side view of a downlight apparatus embodiment.

FIG. 2 illustrates an optical component detached from the downlight apparatus embodiment.

FIG. 3A illustrates a bottom view of a downlight apparatus, showing relative position of a reflector that has an external connector.

FIG. 3B illustrates a perspective view of the reflector.

FIG. 4A illustrates another angle of the reflector.

FIG. 4B illustrates a side view of the reflector.

FIG. 5A illustrates a perspective view of an optical component.

FIG. 5B illustrates a side view of FIG. 5A.

FIG. 6 illustrates an explosive component diagrams of a downlight embodiment.

FIG. 7 illustrates an alternative downlight embodiment.

FIG. 8 illustrates yet another downlight embodiment.

FIG. 9 illustrates a component in another downlight embodiment.

FIG. 10 illustrates another embodiment of a downlight apparatus.

### DETAILED DESCRIPTION

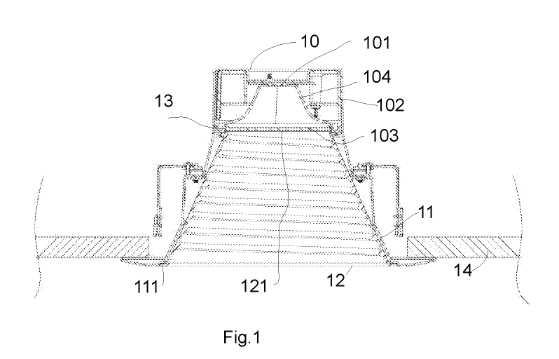

Please refer to FIG. 1. FIG. 1 illustrates a cross-sectional side view of a downlight apparatus embodiment.

In FIG. 1, the downlight apparatus has a main cup 10, a surface ring 11 and a detachable optical component 12.

The main cup 10 has a housing 102, a light source 101, a reflector 104 and a cover 103. The surface ring has an exposed ring engaging with a ceiling 14. The main cup 10 and the surface ring 11 form a fixed module.

The optical component 12, in this example, is a cup with wider bottom and contained within a containing space defined by the surface ring 11. The optical component 12 is attached to the fixed module of the main cup 10 and the surface ring 11 via an external connector 13. The main cup has a second opening 121 and the surface ring has a first opening 111 for passing light.

The external connector 13 is located outside the fixed module of the main cup 10 and the surface ring 11. Please note that the term ‘outside’ means the external connector 13 is located outside the fixed module, though the external connector 13 may be within a containing space defined by external surface of the surface ring in this example. The term ‘external’ means the connection keeps the fixed module an independent unit, and the optical component 12 is attached or detached without affecting normal function of the fixed module.

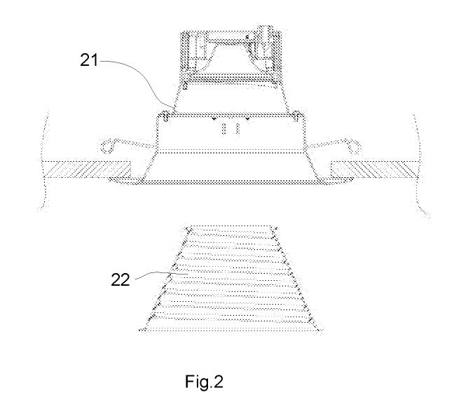

Please refer to FIG. 2. FIG. 2 illustrates an optical component detached from the downlight apparatus embodiment.

In FIG. 2, the optical component 22 is detached from the fixed module 21 of the main cup and the surface ring. Please be noted that even the optical component is detached from the fixed module 21, the fixed module 21 may also function normally, though may have a different light characteristic with the optical component 22 being attached therein.

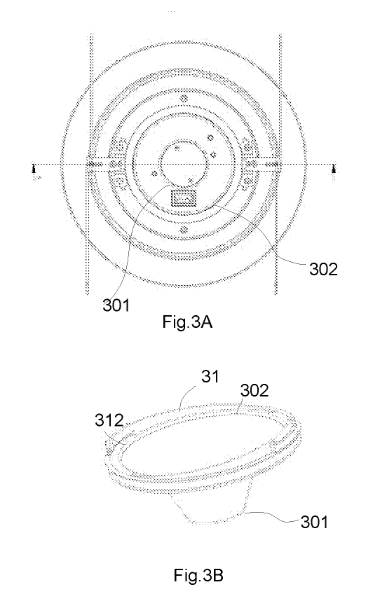

Please refer to FIG. 3A. FIG. 3A illustrates a bottom view of a downlight apparatus, showing relative position of a reflector that has an external connector.

This is a top view of the embodiment of FIG. 1. In FIG. 3A, it is illustrated the relative position of a reflector in the downlight embodiment. The reflector has a narrow top side 301 and a wider bottom side 302.

Please refer to FIG. 3B. FIG. 3B illustrates a perspective view of the reflector.

In FIG. 3B, it is illustrated that there are two tracks 31 with lock structures 312 on the bottom side 302 of the reflector. The top side 301 of the reflector is attached to the main cup.

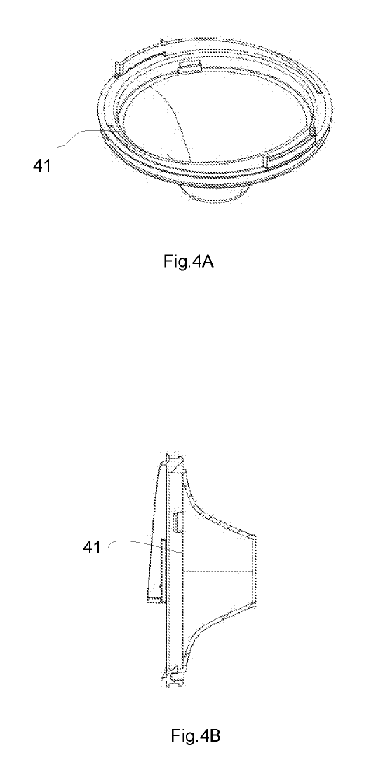

Please refer to FIG. 4A and FIG. 4B. FIG. 4A illustrates another angle of the reflector. FIG. 4B illustrates a side view of the reflector. In FIG. 4A and FIG. 4B, it is clearer to show the structure of the reflector 41 and its tracks as the external connector mentioned above. The tracks has different height in the beginning end and the end.

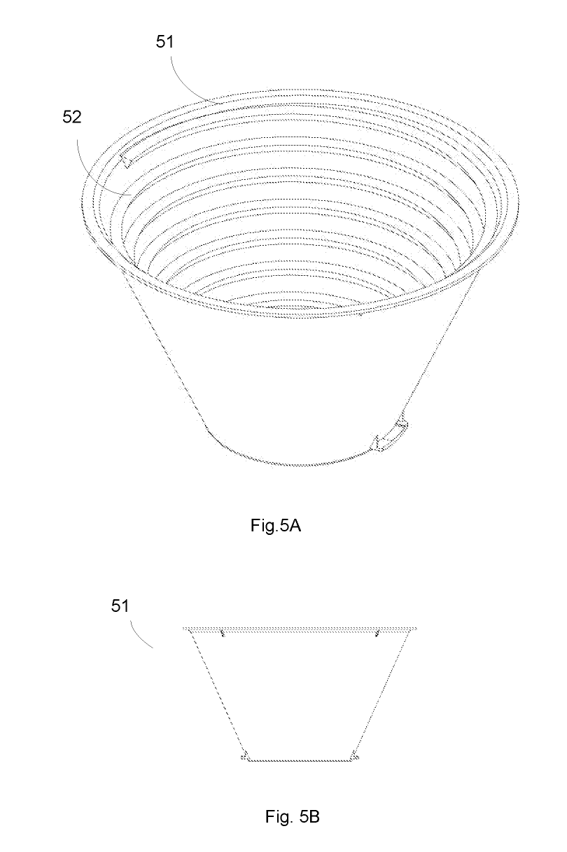

Please refer to FIG. 5A and FIG. 5B. FIG. 5A illustrates a perspective view of an optical component. FIG. 5B illustrates a side view of FIG. 5A.

In FIG. 5A and FIG. 5B, it shows that the optical component 51 may be a cup with two openings at top side and bottom side. There is a spiral convex bar 52 in the internal side of the optical component 51.

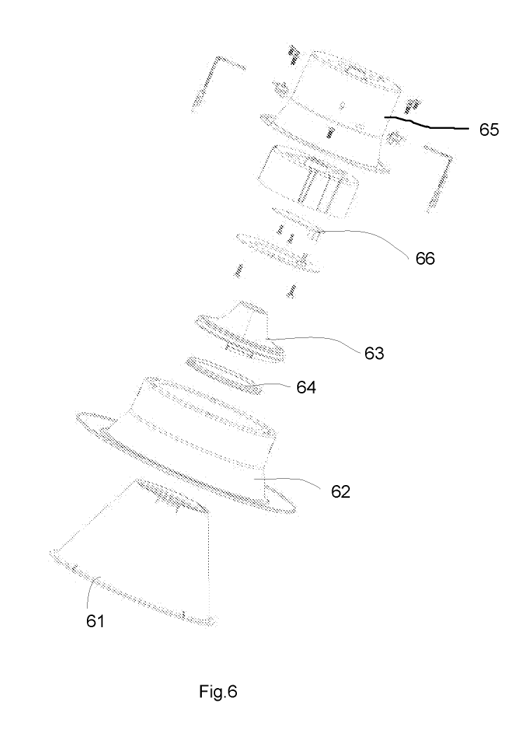

Please refer to FIG. 6. FIG. 6 illustrates an explosive component diagrams of a downlight embodiment.

In FIG. 6, it is clearly to show the relation among major components related to the present invention, including the light source 66, housing of the main cup 65, the reflector 63, a cover 64, a surface ring 62 and the optical component 61.

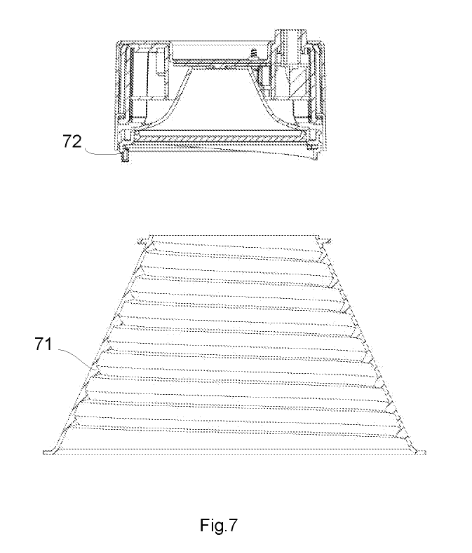

Please refer to FIG. 7. FIG. 7 illustrates an alternative downlight embodiment. Unlike previous embodiments, the surface ring is not so wide and integrated with the main cup as a fixed module 72 that has a first opening for passing light.

The top side of the optical component 71 is in the containing space, though not as the manner as previous examples. Similarly, the optical component 71 is attached to the fixed module 72 for having a second opening for passing light and adjust output light characteristic.

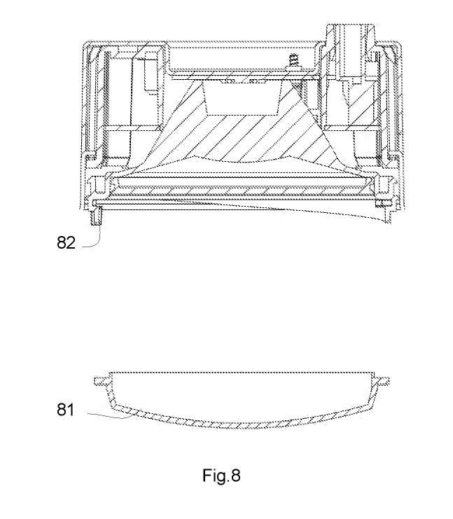

Please refer to FIG. 8. FIG. 8 illustrates yet another downlight embodiment.

In this embodiment, the fixed module 82 does not have a wider ring opening, either. The optical component 81, unlike a cup in previous examples, is a lens 81 for changing light path to generate an adjusted output light.

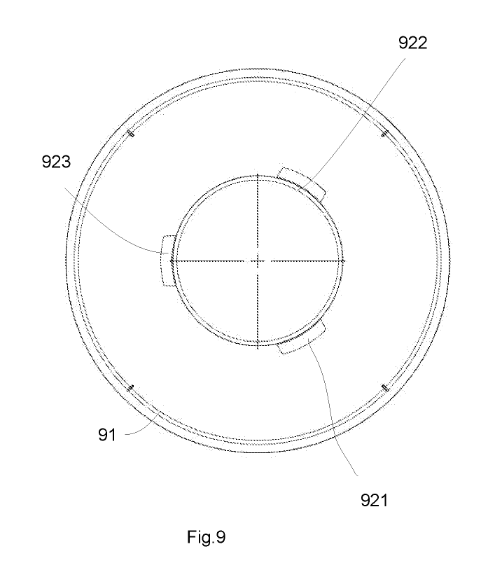

Please refer to FIG. 9. FIG. 9 illustrates a component in another downlight embodiment.

In FIG. 9, unlike two tracks in previous examples, the reflector 91 has three tracks 921, 922, 923 as its external connector.

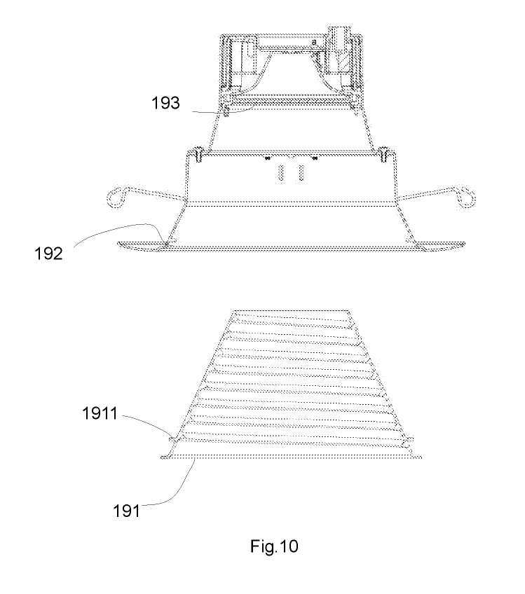

Please refer to FIG. 10. FIG. 10 illustrates another embodiment of a downlight apparatus.

In FIG. 10, the optical component 191 is firstly attached to the main cup 193 with an external connector. Furthermore, the optical component 191 has a second structure 1911 to be attached to a second external connector, a protruding bar, of the surface ring 192. With such double connection, the optical component 191 may be fixed to the downlight more robustly.

According to an embodiment of the present invention, a downlight apparatus has a surface ring, a main cup and an optical component. The optical component is an extended component that may be attached or detached from the downlight apparatus.

The surface ring defines a first opening and a containing space. The main cup is connected to the surface ring. The main cup is used for holding a light source. For example, the light source is a LED plate or a LED right with an associated light guide. Additional components like one or more heat sink structures, a driver circuit, connecting wires, reflector structures, lens or other components may be provided and disposed in the main cup. A housing made of metal covered with plastic material, pure metal or pure plastic material may be used for meeting different design needs.

The main cup has a second opening. The light source emits light to the second opening. The optical component is attached to an external connector in the containing space, which means the optical component may be partly or completely located in the containing space defined by the surface ring. For example, the surface right may has an external cup structure that defines a containing space in the internal side of the external cup. The optical component also has a cup shape but is located completely within the containing space of the internal side of the external cup of the surface ring.

For common downlight apparatuses, there is a circular ring with one side facing downwardly to users and with the other side facing to a ceiling. There is a hole, i.e. the first opening mentioned above, for letting light of the main cup to emit therefrom.

The external connector is located outside the fixed module. In other words, the surface ring and the main cup form an independent module. Even there is no optical component being attached to the fixed module, the fixed module may still work normally and prevents users directly contact with internal components of the fixed module according to various safety standards.

The optical component is detachable from the external connector by rotation. Magnetic components and other structures may be used for enhancing operation experience or used as an alternative option. The surface ring and the main cup forms a fixed module for fixing in a cavity of a ceiling.

In some embodiments, the optical component is an anti-glare cup. For example, a light emitted from a downlight may cause glare effect, making user eyes uncomfortable. A cup with a wider bottom opening with some surface material may help decrease glare effect of the downlight apparatus.

In some embodiments, the first opening is larger than the second opening. The optical component has a first side and a second side opposite to each other. The first side of the optical component of the optical component is attached to the external connector. The second side of the optical component has a peripheral part to be held by a user to rotate for bringing the first side of the optical component rotated with respect to the external connector to leave connection with the external connector.

In such case, there may be certain space remaining between the surface ring and the optical component so that users may extend part of their fingers in the space to hold the external side of the optical component to rotate the optical component. In one rotation direction, e.g. counter-clockwise, the optical component is fixed to the external connector. In the other direction, e.g. clockwise, the optical component is detached from the external connector.

In some embodiments, since the optical component is exposed outside, compared with components of the main cup, the optical component may stick with dust for a period of time. As mentioned above, the optical component is easily to be detached from the downlight apparatus. Thus, users may detach the optical component to clean and attach the optical component back to the downlight apparatus after cleaning.

In some embodiments, there is another optical component to be rotated to attach to the external connector to replace the optical component when the optical component is detached from the external connector. This means manufacturers may provide multiple optical components with the same types or different types. For example, manufacturers may prepare a kit containing multiple types of optical component to be sold together with the downlight apparatus. Users may replace an original optical component with another optical component to change color, set desired light effect or replacing broken ones.

For example, some optical component may have a reception structure for holding a transparent film slide printed with image pattern of Christmas or birthday marks. When Christmas is coming, users may attach such optical component to the corresponding downlight to create Christmas feeling. After Christmas, users may replace the optical component with a normal optical component.

Therefore, persons of ordinary in the art should know that there are various applications for such designs. Modifications based on such disclosure are supposed to be regarded falling in the invention scope.

In some embodiments, there is a lock component at rotation end of the external connector to lock the optical component. For example, a hook structure using flexible and elastic characteristic of plastic material may be used as the lock for holding the optical component. Unless a larger force is applied, the optical component may robustly stay in its original position defined by the lock component, which prevents the optical component gets loosen during time and falls accidently.

In addition, the lock component may refer to a protective groove, hook or similar structure to prevent the optical component directly falling down. For example, a groove with a curved end may ensure the optical component kept a certain connection with the external connector even the optical component is loosen from the external connector. Users may move in a specific direction to completely detach the optical component from the external connector.

In some embodiments, the first side of the optical component has a smaller perimeter than the second side of the optical component. This design may maximize light output, preventing unnecessary light lost during light transmission path.

In some other embodiments, the first side of the optical component has a larger perimeter than the second side of the optical component. This design may help focus light, cutting unwanted light direction, meeting certain needs.

The first side and the second side of the optical component may even be the same. For example, the optical component may be a lens for changing light beam angle, e.g. the half intensity angle of the downlight apparatus.

In some embodiments, the external connector is located at a bottom of the main cup. In addition, the external connector may have two or more tracks for guiding the optical component when the optical component is rotated with respect to the external connector. Each track may be made of a groove, a convex structure, a concave structure or any other structure that creates a sliding path for attaching the optical component.

Alternatively, the tracks may be disposed on the optical component and the external connector is a convex block, stick or other corresponding structures to slide along the tracks.

In some embodiments, two ends of each convex track has different height. For example, the track may has a lower beginning end and taller ending end.

In some embodiments, the main cup has a cover located at a bottom of the main cup for sealing the main cup, preventing dust entering the second opening of the main cup, and the external connector is located on the cover. The cover may be a diffusion device for passing light and soften light passing through. The cover may be a lens with one convex or concave optical structure, or multiple micro-optical structures for meeting certain optical requirements.

The external connector may be disposed at a bottom end of the main cup where the bottom end surrounds the cover. In other words, the external connector is placed on the cover.

In addition to the external connector, there may be another connector located in the surface ring to further attach to the optical component to form an even more robust fixing connection of the optical component.

Alternatively, the external connector may be located at the surface ring. In other words, the major connection is between the surface ring and the optical component. Please be noted that the surface ring and the main cup may be two separate units but may also be made of a one piece unit, e.g. made with the same molding process.

In some embodiments, the optical component is made of heat dissipation material for helping dissipate heat of the downlight apparatus. The external connector may bring heat of the main cup to be dissipated by the optical component. In other words, in addition to perform as an optical component to adjust light effect of the downlight apparatus, the optical component is also used for enhancing heat dissipation.

Fins, convex structures, metal material or other related features may be further provided in the optical component for even improving heat dissipation.

In some other embodiments, the main cup may have audio components to generate sounds like music received from a mobile phone via wireless connection. The optical component may have a shape for enhancing sound effect of the sound generated from the audio component in the main cup. Such audio component may include wireless circuits, decoders for rendering sound information, driver circuits to drive speakers to generate sound wave, and other necessary components. It is important to adjust sound path to get desired sound effect. An optical component that may be replaced with other structures may be very convenient to change audio effect, by simply replacing the detachable optical component with another optical component of different audio effect.

In some embodiments, the optical component may include a lens for changing a light beam angle of the main cup. For example, the original light may be a diffusion soft light. A focus lens of an optical component may focus the light to form a focused light beam output.

In some embodiments, the optical component may have a color filter for changing color of output light of the downlight apparatus. For example, a red film may bring a red light when the red film is installed on the optical component.

In some embodiments, the optical component may have a spiral convex structure in an internal side of the optical component. Such design may strength structure and may provide better appearance.

In addition to the above-described embodiments, various modifications may be made, and as long as it is within the spirit of the same invention, the various designs that can be made by those skilled in the art are belong to the scope of the present invention.

1. A downlight apparatus, comprising:
a surface ring defining an first opening and a containing space;
a main cup connected to the surface ring, the main cup being for holding a light source, the main cup having a second opening, the light source emitting light to the second opening, the surface ring and the main cup forming a fixed module for fixing in a cavity of a ceiling; and
an optical component attached to an external connector of the fixed module in the containing space, the external connector being located outside the fixed module, the optical component being detachable from the external connector by rotation.

2. The downlight apparatus of claim 1, wherein the optical component is an anti-glare cup.

3. The downlight apparatus of claim 1, wherein the first opening is larger than the second opening, the optical component has a first side and a second side opposite to each other, the first side of the optical component of the optical component is attached to the external connector, the second side of the optical component has a peripheral part to be held by a user to rotate for bringing the first side of the optical component rotated with respect to the external connector to leave connection with the external connector.

4. The downlight apparatus of claim 3, wherein the optical component is detached for cleaning and is rotated back to attach to the external connector after cleaning.

5. The downlight apparatus of claim 3, wherein there is another optical component to be rotated to attach to the external connector to replace the optical component when the optical component is detached from the external connector.

6. The downlight apparatus of claim 3, wherein there is a lock component at rotation end of the external connector to lock the optical component.

7. The downlight apparatus of claim 3, where the first side of the optical component has a smaller perimeter than the second side of the optical component.

8. The downlight apparatus of claim 3, wherein the first side of the optical component has a larger perimeter than the second side of the optical component.

9. The downlight apparatus of claim 1, wherein the external connector is located at a bottom of the main cup.

10. The downlight apparatus of claim 9, wherein the external connector comprises at least two convex tracks for guiding the optical component when the optical component is rotated with respect to the external connector.

11. The downlight apparatus of claim 10, wherein two ends of each convex track has different height.

12. The downlight apparatus of claim 9, wherein the main cup has a cover located at a bottom of the main cup for sealing the main cup, preventing dust entering the second opening of the main cup, and the external connector is located on the cover.

13. The downlight apparatus of claim 9, wherein the main cup has a cover located at a bottom of the main cup for sealing the main cup, preventing dust entering the second opening of the main cup, and the external connector is disposed at a bottom end of the main cup where the bottom end surrounds the cover.

14. The downlight apparatus of claim 9, further comprising a second connector located at the surface ring for further attaching to the optical component.

15. The downlight apparatus of claim 1, wherein the external connector is located at the surface ring.

16. The downlight apparatus of claim 1, wherein the optical component is made of heat dissipation material for helping dissipate heat of the downlight apparatus.

17. The downlight apparatus of claim 1, wherein the optical component enhances sound effect of a sound generated from an audio component in the main cup.

18. The downlight apparatus of claim 1, wherein the optical component comprises a lens for changing a light beam angle of the main cup.

19. The downlight apparatus of claim 1, wherein the optical component has a color filter for changing color of output light of the downlight apparatus.

20. The downlight apparatus of claim 1, wherein the optical component has a spiral convex structure in an internal side of the optical component.
